(19) United States
(12) Patent Application Publication
(10) Pub. No.: US 2007/0257513 A1
(43) Pub. Date: Nov. 8, 2007

(54) Aerodynamic air deflection system

(76) Inventor: Karl Schwartz, Grove City, OH (US)

Correspondence Address: NEAL T. HAUSCHILD, 4310 SUNBURY ROAD, GALENA, OH, 43021, US

(21) Appl. No.: 11/382,102

(22) Filed: May 8, 2006

(51) Int. Cl. B62D 35/00

(52) U.S. Cl. 296/180.3

(57) ABSTRACT

A tractor and trailer coupled together in tandem towing relationship is provided with an air deflector system attached to the tractor for aerodynamically reducing the drag on such combination by enclosing the space between the cab of the tractor and the trailer. A support means is attached to the frame of the tractor or body of the trailer. Two side fairings are movably attached to the support means for extending from the rear of the cab to the trailer, and wherein the side fairings mate with a top fairing. A means is provided for moving the side fairings from one position to another based upon the alignment between the trailer and the tractor.

### CROSS REFERENCE TO RELATED APPLICATION

### STATEMENT REGARDING FEDERALLY SPONSORED RESEARCH OR DEVELOPMENT

### STATEMENT REGARDING FEDERALLY SPONSORED RESEARCH OR DEVELOPMENT

### REFERENCE TO SEQUENCE LISTING

### BACKGROUND OF THE INVENTION

The present invention relates to an air deflection system for aerodynamically reducing the drag on a vehicle having a drive vehicle coupled together in tandem towing relationship with a trailer. More specifically this invention relates to changing the aerodynamic characteristics of a tractor-trailer combination by the use of air fairings to more aerodynamically blend the impinging air around the vehicle. Most specifically this system provides for the automatic positioning of the air deflectors in accordance with the relationship between the tractor-trailer.

Various fairings and streamlining devices have been tried to reduce the aerodynamic drag that results in a typical tractor-trailer combination. The initial devices provided an air fairing mounted upon the roof of the cab in an attempt to aerodynamically blend the top of the cab with the top of the trailer. Later, fairings were not only mounted to the cab they were also mounted to the front of the trailer, while side fairings were attached to the cab and extended to near the front of the trailer.

U.S. Pat. No. 4,152,755 for a Vehicle Drag Reducer discloses a passive air fairing system having a top and two side fairings which are attached by hinges at the cab. Each fairing extends from the cab to overlap with the trailer and is held against the trailer by springs. This type of system has several disadvantages.

First, by attaching to the cab portion of the tractor, additional loading forces are applied to the cab. The cab is generally mounted to the frame of the tractor through a spring type mounting system which provides some cushion to the occupants. The additional weight of the fairing system may result in decreased comfort to the occupants and/or additional modifications to handle the increased loading forces.

Secondly, the constant contact of the fairings with the trailer during turns results in a rubbing between the two surfaces producing the possibility of abrasion wear to the sides and top of the trailer and to the ends and sides of the fairings. This rubbing further translates into a frictional force which must be overcome in order to smoothly effect the turning of the vehicle. This increases the amount of force required and the length of time involved to turn the vehicle. This presents a safety problem to the operator where quick handling and response time are essential in an emergency or semi-emergency situation.

Thirdly, if the side fairings do not overlap sufficiently they may become caught and bent between the tractor and trailer during a turn or maneuver. For example, if the tractor is in a right hand turn the gap between the cab and the trailer becomes smaller on the right side of the vehicle while the gap on the left becomes larger. If the left side panel or fairing is not sufficiently long enough the length of the gap will exceed the length of the side panel. Since the side panels are under spring tension, the left one will be moved into the gap. As the tractor-trailer comes out of the turn to come back into alignment the gap on the left will decrease with the left panel caught or wedged between the cab and the front of the trailer. This may result in damage to the side panel and/or steering and maneuverability problems. If the panel is made sufficiently long enough to prevent this occurrence the increased length results in extra weight and torque on the hinge point and the cab.

Fourthly, if the side panels are aerodynamically designed, the lifting force on the panels or fairings is also increased. The point of attachment being at the end of the panel does not balance out these lifting forces. This then requires the usage of extremely large springs to hold the panels down or in contact with the trailer thus increasing the problems above.

Several adjustable or articulated deflection systems have been tried where a top fairing is slidably attached to the leading edge of the roof of the cab. The trailing edge is then raised or lowered depending upon various circumstances. This is illustrated by U.S. Pat. Nos. 4,102,578; 4,375,898 and 4,458,937.

U.S. Pat. No. 4,156,543 illustrates the adjustable top fairing and additionally includes two flexible side panels which are slidably secured to the rear of the cab by a hinge spring combination and are anchored to the side edge of the trailer by tie cords. This arrangement physically restricts the side panels to the trailer by not allowing their free movement, thus, increasing the force required to maneuver the tractor trailer. Furthermore, the top panel fails to fully enclose the top of the air space thereby increasing drag.

Other various deflection devices have been proposed in order to reduce the air draft, such as air inflated structures, U.S. Pat. Nos. 3,945,677; 4,036,519 and 4,611,847; and telescoping or bellows like structures such as U.S. Pat. Nos. 3,711,156 and 4,311,334.

All of the systems described above are passive systems inasmuch as they rely on the trailer to move and/or reposition the side shields in order to facilitate a turn. Furthermore, most, if not all of the above systems, are not readily adaptable for use with a variety of tractor/trailer combinations without major alterations. This later point is very important in that it is commonly known that there are more trailers in service than there are tractors. It is very common for one tractor to be used with a number of different trailers. Therefore, the air deflector system must be readily adaptable to be used with a variety of different trailers.

The air deflection system of this invention is used with a drive vehicle coupled together in a tandem towing relationship with a trailer, such as a tractor-trailer combination. The air deflection system comprises a mounting frame which is attached to the frame of the drive vehicle and two side air fairings. The top fairing is typically installed as a cone which may have been converted to livable space within the cab. The two side fairings are also movably attached to the mounting frame, one on each side of the drive vehicle. Each side fairing extends from the drive vehicle rearwardly towards the trailer and wherein the top portion of the side fairing mates with the top fairing or cone. This results in the air deflection system being mounted independently from the cab of the drive vehicle.

This invention further provides for an air deflector system for aerodynamically reducing the drag on a vehicle having a tractor and trailer coupled together in a tandem towing relationship, by enclosing the space formed between the cab and the trailer. The air deflector system includes: a support means attached to the tractor frame and two side fairings slidably attached to said mounting frame for movement from a closed position to an extended position. The top fairing in the closed position extends from a top portion of the cab to overlap at its trailing edge with a top portion of the trailer to enclose the top of the space. The side fairings in their closed position extend from the tractor to overlap at their trailing edge a side portion of the trailer. Each side fairing has a top portion which mates with the top fairing when each is in its closed position. When the side fairing are in their extended or open position the trailing edge of the side fairing is positioned away from the side of the trailer.

Furthermore in accordance with the objects and other aspects and features of the present invention, there is disclosed a system for a towing vehicle-trailer combination comprising: (a) a support frame mounted on a frame portion of the towing vehicle, (b) a complementary pair of side fairings slidably mounted on the support frame, (c) a top airfoil slidably and slidably mounted on the support frame, and (d) an active means for independently articulating the fairings and airfoil responsive to a change in relative position between the towing vehicle and the trailer.

There is also disclosed a sensing system to determine the relative position between the towing vehicle and the trailer. There is also disclosed a control system responsive to the sensing system to independently actuate the fairings.

The following is a brief description of the drawings in which like parts bear like reference numerals and in which:

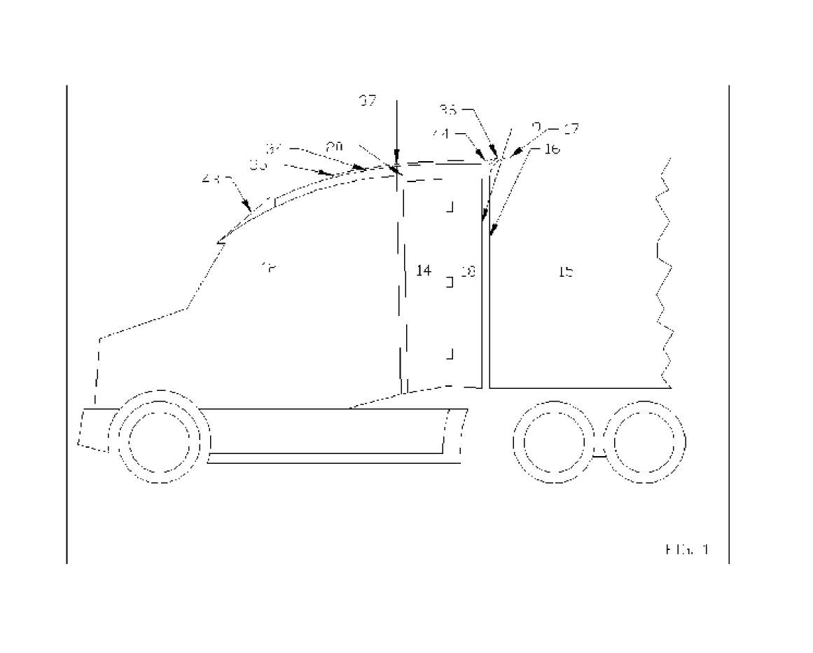

FIG. 1 is a side perspective view of a tractor/trailer combination having one embodiment of the air deflector system attached;

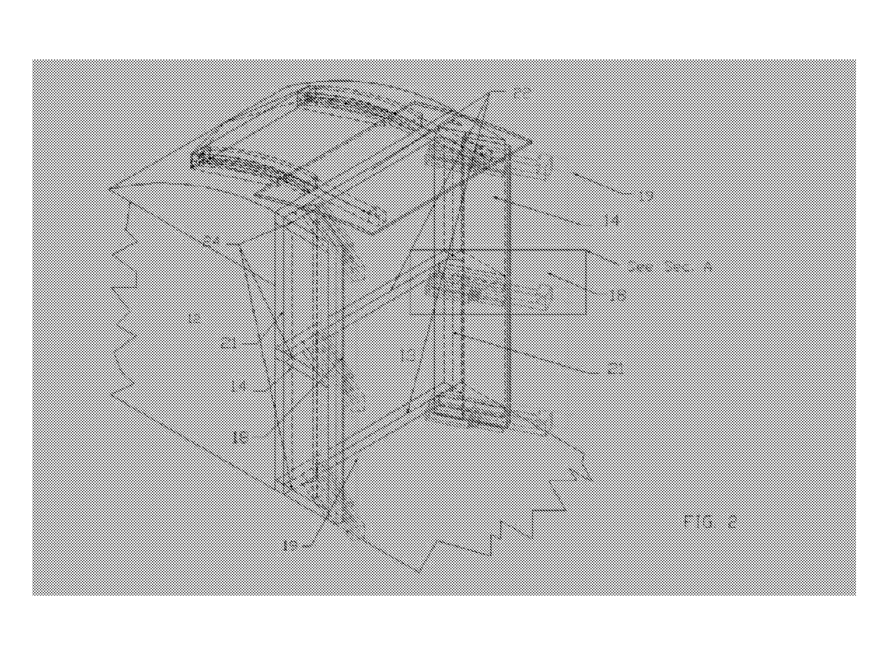

FIG. 2 is a rear perspective view of the air deflecting system attached to the tractor as viewed from the rear of the tractor;

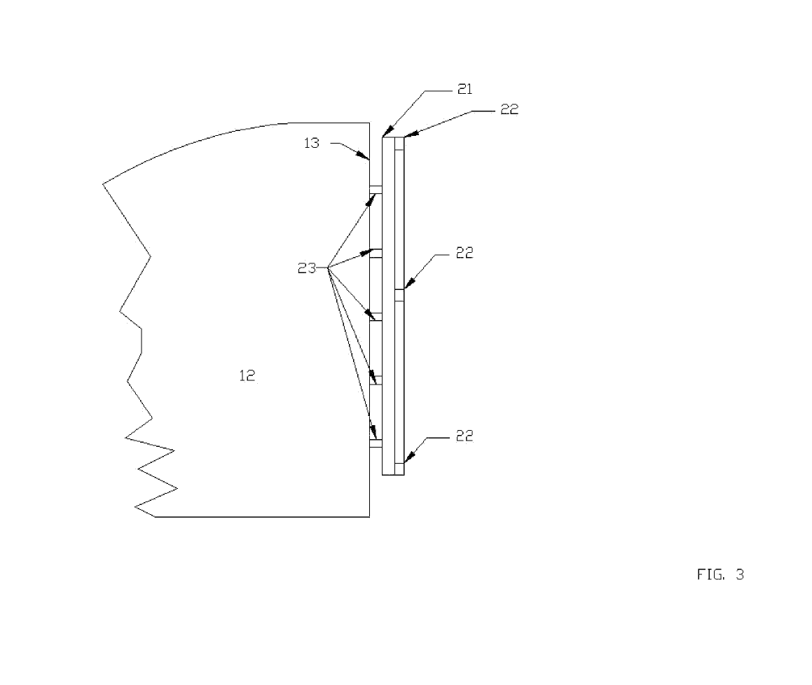

FIG. 3 is a side view of a portion of the fairing actuation mechanism;

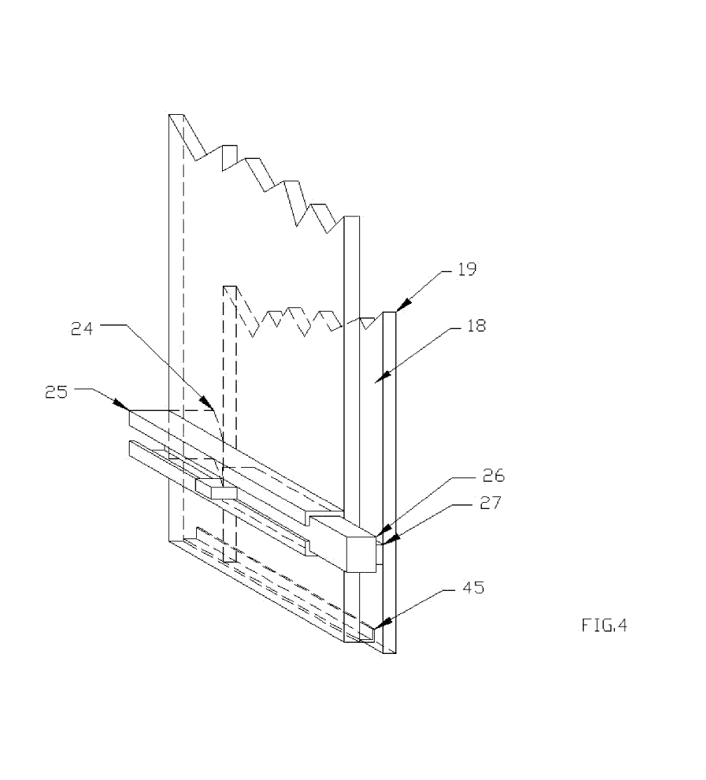

FIG. 4 is an enlarged view of the side fairing actuation mechanism;

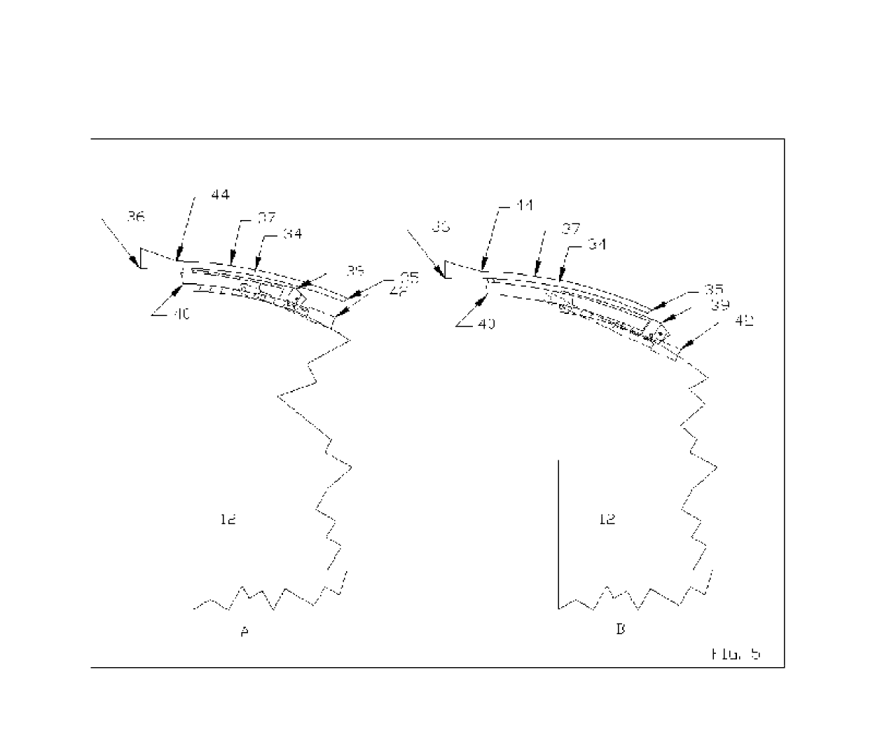

FIG. 5A is a top view of the tractor-trailer with the fairing retracted to more clearly illustrate the operation of the side fairings; FIG. 5B is a top view of the tractor-trailer with the fairing deployed or extended to more clearly illustrate the operation of the side fairings;

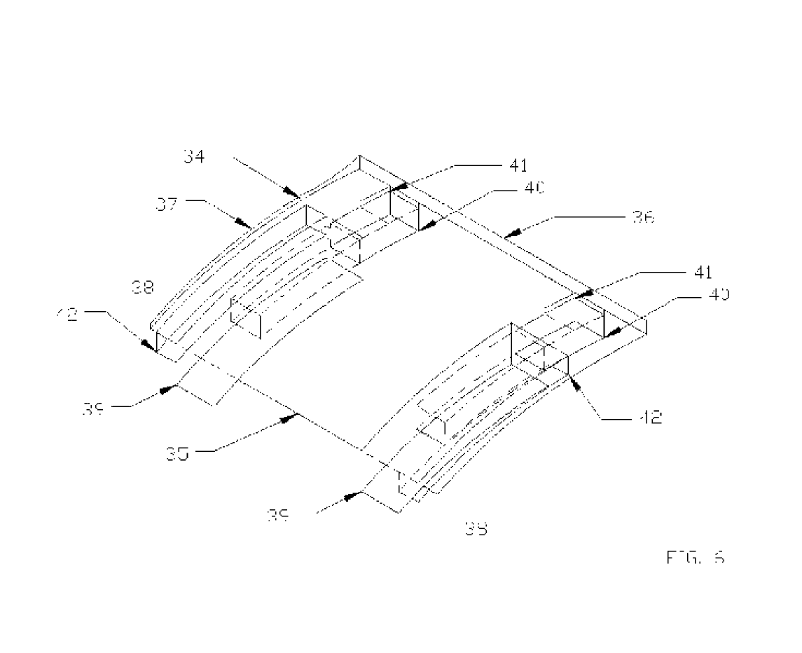

FIG. 6 is a top views of the tractor-trailer during a left handed turn, the top fairing having been removed to more clearly illustrate the operation of the side fairings;

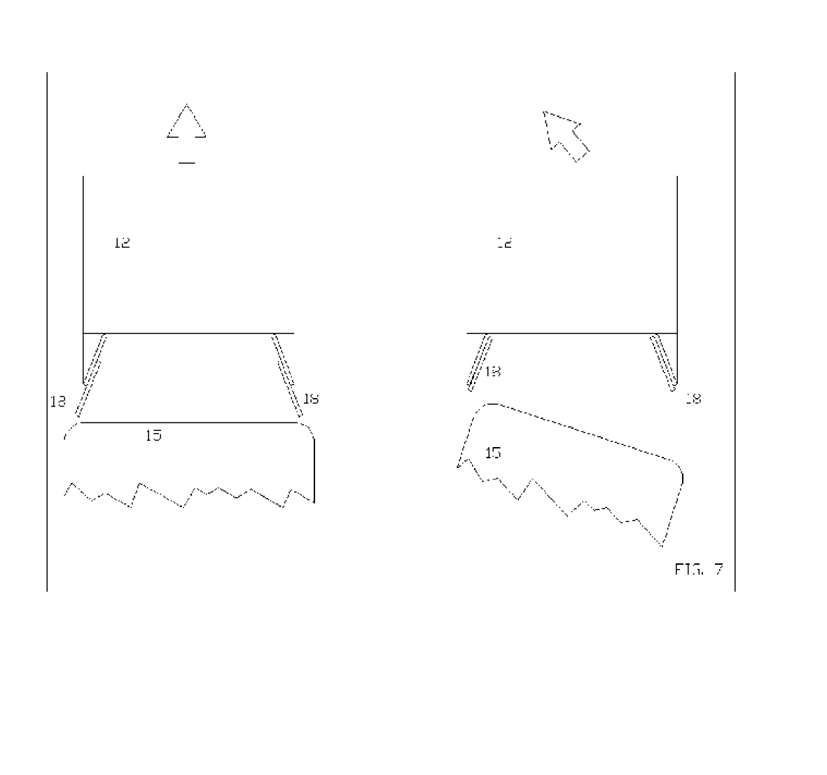

FIG. 7 is a partial side perspective view of the tractor-trailer and the air deflector system during a left handed turn;

Referring now more particularly to the drawings, an air deflector system embodying the principles of the present invention is shown generally in FIGS. 1 and 2. The air deflector system 14 is shown as mounted on a typical tractor-trailer truck combination wherein a tractor 12 is coupled together in tandem towing relationship with the trailer 15. The tractor 12 being the drive unit which provides the means for driving the trailer 15. The tractor 12 has a back facing plane 13 and the trailer 15 has a leading edge 16 and a front, top edge 17.

The air deflector system 14 has three fairings, a top 34 and two side fairings 18 (one on each side of the tractor 12) which provide for aerodynamically blending the air around the trailer 15. The top fairing 34 attaches directly to the top of the tractor 12 extends from a top portion of the tractor 12 rearwardly to overlap at the front, top edge 17 of the trailer 15. The top fairing 34 aerodynamically blends the top of the tractor 12 from the back facing plane 13 with the front, top edge 17 of the trailer 15 by means of a curved (convex) outer surface 37 of the top fairing 34.

The side fairings 18, each spaced from the rear of the cab 12 extend rearwardly to overlap at their trailing edge 19 a leading edge 16 of the trailer 15. The side fairings 18 aerodynamically blend the tractor 12 to the trailer 15.

The top fairing 34 mates with each side fairing 18. This provides for a more effective sealing of the gap between the tractor 12 and trailer 15. The top fairing 34 consists of a slide bracket 39 which is fixedly mounted to the top of the tractor 12. A slide bar 40 is fitted into the slide bracket 39. A mounting block 41 secures the slide bar 40 to the trailing edge 36 of the top fairing 34. The slide bar 40 which mates with the side fairings 18. Preferably, the top fairing 34 overlaps the top portion of the side fairing 18 to provide a better sealing of the fairings, thereby reducing the possibility of air entering into the enclosed space between the tractor 12 and trailer 15.

Now referring more particularly to FIGS. 2 and 3 the side air fairings 18 are mounted to the tractor 12 by attaching to a support structure which is a mounting frame shown generally at 20. The mounting frame 20 comprises vertical members 21 and horizontal members 22 which are attached to the back facing plane 13 of the tractor 12 with shock absorbent bushings 23 to prevent any vibration.

The mounting frame 20 is comprised of vertical members 21 to which are attached a series of horizontal members 21. At the intersection of the vertical members 21 and the horizontal members 22, individual fairing brackets 24 are welded directly to the mounting frame 20.

A side fairing attachment means, shown generally at 23, is attached to the mounting frame 20 for movably attaching the side air fairing 18 to the mounting frame. The attachment means comprises a slide bracket 25 which is bolted to each fairing bracket 24. A slide bar 25 is inserted into the slide bracket 25. A side mounting block 27 is used to secure the slide bar 26 to the side fairing 18. To cause the sliding of the slide bar 26 within the confines of the slide bracket 25, actuator unit 29 is mounted to each fairing bracket 24. The actuator 29 can be hydraulic or electric. The actuator has a base 30 and a manipulation end 32. The manipulation end is attached to the slide bar 26 and the base 30 is attached to the fairing bracket 24. Thus, upon actuation, the side air fairing 18 causes the slide bar 26 to move horizontally along the slide bracket 25 causing the attached side fairing 18 to move evenly along a vertical plane parallel to the leading edge of the trailer 16.

The side fairing actuation mechanism is more clearly illustrated in the enlarged view in FIG. 4 which illustrates the right side fairing actuation mechanism, it being understood that this is also applicable to the left side actuation mechanism.

A top fairing attachment means, shown generally at 34, is attached directly to the top of the tractor 12. The attachment means comprises a slide bracket 39 which is bolted to the tractor 12 between the front air scoop 43 and the rear air scoop 44. A top slide bar 40 is inserted into the top slide bracket 39. A top mounting block 41 is used to secure the slide bar 40 to the top fairing 34 at the trailing edge 36. To cause the sliding of the slide bar 40 within the confines of the slide bracket 39, actuator unit 38 is mounted to each top slide bracket 39. The actuator 38 can be hydraulic or electric. The actuator has a base 42 and a manipulation end 43. The manipulation end is attached to the top slide bar 40 and the base 42 is attached to the top slide bracket 39. Thus, upon actuation, the top air fairing 34 causes the slide bar 40 to move horizontally along the slide bracket 39 causing the attached top fairing 34 at the trailing edge 36 to move evenly along a horizontal plane parallel to the front, top edge 17 of trailer 15.

Now referring again to FIG. 2, it can be appreciated from the foregoing description that because the mounting frame 20 is attached directly to the tractor 12, that there is no need for a change of the cab suspension or reinforcement of the cab. Therefore, the present invention eliminates the problem of attaching the fairing system directly to the tractor 12.

The side fairings 18 of the present invention have been aerodynamically designed to provide low wind resistance.

Frame mounting of the system allows for a simpler attachment to a variety of tractors while allowing the torsional, wind, etc., forces generated to be transferred directly to the tractor frame. This allows the cab suspension to work independently of the air deflector system and thus does not require additional reinforcement. The operation of the air deflecting system is best illustrated by FIGS. 5-7 to more clearly illustrate the operation of the side fairings.

While certain representative embodiments and details have been shown for the purpose of illustrating the invention, it will be apparent to those skilled in this art that various changes and modifications may be made therein without departing from the scope of the invention.

What is claimed is:

1. An air deflector system for use with a drive vehicle coupled together in tandem towing relationship with a trailer, the drive vehicle having a frame and a cab portion mounted upon said frame, said air deflector system comprising:
(a) a mounting frame attached to the frame of the drive vehicle;
(b) two side fairings movably attached to said mounting frame, one on each side of the drive vehicle, each extending from the drive vehicle rearwardly towards the trailer and having a top portion which mates with a top fairing; and wherein side fairings move during the operation of the vehicle.

2. The air deflector system of claim 1 further comprised by a means for moving side fairings from one portion to another.

3. The air deflector system of claim 2 wherein said means comprises:
a sensing means for determining the alignment between the drive vehicle and the trailer;
and an actuation means coupled to said fairings for actuating said fairings from one position to another position in response to said alignment.

4. The air deflector system of claim 3 wherein each said fairing is slidably attached to said mounting frame.

5. The air deflector system of claim 4 wherein said side fairings are slidably attached to said mounting frame at a point wherein at a normally closed position the outward aerodynamic resulting forces acting on said side fairings are substantially balanced.

6. The air deflector system of claim 5 wherein each side fairing overlaps a side of said trailer, and each said side fairing interlocks with said top fairing; and wherein in response to said sensing means said actuation means extends at least one said side fairings outwardly from said drive vehicle.

7. An air deflector system for aerodynamically reducing the drag on a vehicle having a tractor and trailer coupled together in a tandem towing relationship, said tractor having a frame and a cab portion mounted there upon and said trailer spaced a predetermined distance from said cab, forming a space there between, said air deflector system comprising:
a support means attached to the tractor frame;
two side fairings movably attached to said mounting means for movement from a closed position to an extended position with one on each side of the tractor and each in said closed position extending from the tractor to overlap at a trailing edge a side portion of the trailer, each side fairing having a top portion which mates with the top fairing when said top and side fairings are all in said closed position and in an extended position the side fairing is slid to position the trailing edge of the side fairing away from the side of the trailer a predetermined distance; and
whereas with each fairing in the closed position the space between said tractor and trailer is substantially enclosed.

8. The system of claim 7 further comprising:
(a) a means for sensing the alignment between the tractor and the trailer; and
(b) a means for moving the fairings from one position to another; and
(c) a means coupled to the means of (a) and (b) for controlling the movements of the fairings from one position to another.

9. The system of claim 8 wherein said top fairing has a curved top portion and two diametrically opposed curved side portions each having a contoured lower edge for mating in overlapping relationship with a contoured outer edge of said top portion of said side fairings.

10. The system of claim 9 further comprising an attachment means for slidably and slidably attaching said top fairing to said support means, and wherein said side fairings are slidably attached to said support means.

11. The system of claim 10 wherein said means for moving said fairings includes three driving means, one for each fairing, for driving said fairings from said closed position to said extended position upon actuation by said control means;
three biasing means, one for each fairing for returning the fairings to said closed position.

12. The system of claim 8 wherein said driving means comprises a ram mount.

13. The system of claim 12 wherein at least one said biasing means comprises two air springs and at least one other biasing means comprises springs.

14. The system of claim 8 wherein said driving means comprises an electric motor.

15. The method of aerodynamically reducing the drag on a vehicle having a tractor having a frame and a cab mounted thereupon, and trailer coupled together in a towing relationship comprising the steps of
(a) deflecting oncoming air by means of a top and a first and second side fairing; said top and side fairings, when in a closed position, enclosing a space between the cab and the trailer, each said fairing movably attached to a support means which is attached to the frame of the tractor;
(b) determining when the tractor-trailer is turning; and
(c) actuating the top air fairing to an open position and actuating the first side fairing to a first open position at a predetermined point or degree in said turn.

16. The method of claim 15 wherein said side fairing are actuated by a ram mechanism.

17. The method of claim 15 wherein said side fairing are actuated by an electric motor that extends and distends the fairings via a gear mechanism.

18. An air deflector system for aerodynamically reducing the drag on a vehicle having a tractor and trailer coupled together in a tandem towing relationship, said tractor having a frame and a cab portion mounted there upon and said trailer spaced a predetermined distance from said cab, forming a space there between, said air deflector system comprising:
a support means attached to a body of said trailer;
two side fairings movably attached to said mounting means for movement from a closed position to an extended position with one on each side of said trailer and each in said closed position extending from said trailer to overlap at a leading edge a side portion of the tractor, each side fairing having a top portion which mates with the top fairing when said top and side fairings are all in said closed position and in an extended position the side fairing is slid to position the leading edge of the side fairing away from the side of said tractor a predetermined distance; and
whereas with each fairing in the closed position the space between said tractor and trailer is substantially enclosed.

19. The system of claim 18 further comprising:
(a) a means for sensing the alignment between the tractor and the trailer; and
(b) a means for moving the fairings from one position to another; and
(c) a means coupled to the means of (a) and (b) for controlling the movements of the fairings from one position to another.

20. The system of claim 19 wherein said top fairing has a curved top portion and two diametrically opposed curved side portions each having a contoured lower edge for mating in overlapping relationship with a contoured outer edge of said top portion of said side fairings having an attachment means for slidably and slidably attaching said top fairing to said support means, and wherein said side fairings are slidably attached to said support means.
